(19) United States
(12) Patent Application Publication
(10) Pub. No.: US 2023/0073619 A1
(43) Pub. Date: Mar. 9, 2023

(54) ELECTRONIC COMMUNICATION DEVICE

(71) Applicant: Infineon Technologies AG, Neubiberg (DE)

(72) Inventors: Walther Pachler, Graz (AT); Josef Gruber, Sankt Ruprecht An Der Raab (AT); Andreas Woerle, Graz (AT); Juergen Hoelzl, Graz (DE)

(21) Appl. No.: 17/823,542

(22) Filed: Aug. 31, 2022

(30) Foreign Application Priority Data
Sep. 6, 2021 (DE) 102021123001.2

(51) Int. Cl. H04B 5/00; H02J 50/12

(52) U.S. Cl. CPC H04B 5/0037; H02J 50/12

(57) ABSTRACT

An electronic communication device having a coil antenna with a first end connection, a second end connection, and a mid-connection, a communication device which is connected between the first end connection and the mid-connection and is configured to communicate with another communication device via the coil antenna, and an energy generation circuit which is connected between the first end connection and the second end connection and is configured to receive energy via the coil antenna and to supply at least one component of the electronic communication device with the received energy.

### TECHNICAL FIELD

Exemplary embodiments relate in general to electronic communication devices.

### BACKGROUND

Electronic communication devices such as cell phones, smartwatches and chip cards are frequently equipped with support for near field communication (NFC), for example in order to enable cashless payments. The carrier (13.56 MHz) used for this purpose can also be used to transmit energy to the electronic devices in order to provide them with wireless charging (WLC). This energy generation from the NFC-RF (radio frequency) field by the electronic devices is also referred to as energy harvesting. The electronic device which receives energy is referred to as the WLC-L (WLC listener). An NFC-based energy generation of this type is very important for electronic devices such as wearables, since fewer components can be used (e.g. compared with Qi-based charging, since a Qi receiver is then no longer required).

An energy generation circuit is typically provided for NFC-based energy harvesting, said energy generation circuit being connected to the NFC antenna of the electronic device in parallel with a communication circuit which communicates via the NFC antenna (e.g. an NFC tag chip or a secure element, wherein both circuits can be integrated into one chip). As a result, however, the efficiency of the energy harvesting is restricted by the voltage regulator provided for the communication circuit (e.g. for the NFC tag chip or the secure element). This is not flexible and possibly also not optimal for the input voltage of the energy generation circuit of the electronic device.

Methods are therefore desirable which allow the voltage distribution and energy distribution between the communication circuit and the energy generation circuit in a communication device to be improved in the case of (e.g. NFC-based) energy harvesting.

### SUMMARY

According to one exemplary embodiment, an electronic communication device is provided, having a coil antenna with a first end connection, a second end connection and a mid-connection (which does not necessarily have to be arranged so that it divides the coil antenna in a 1:1 ratio), a communication device which is connected between the first end connection and the mid-connection and is configured to communicate by means of the coil antenna with another communication device, and an energy generation circuit which is connected between the first end connection and the second end connection and is configured to receive energy via the coil antenna and to supply at least one component of the electronic communication device with the received energy.

### BRIEF DESCRIPTION OF THE DRAWINGS

The figures do not reflect the actual size ratios, but are intended to serve to illustrate the principles of the different exemplary embodiments. Different exemplary embodiments are described below with reference to the following figures.

FIG. 1 shows an NFC communication arrangement.

FIG. 2 shows a communication arrangement with a communication device according to one embodiment.

FIG. 3 shows a communication device according to a further embodiment.

FIG. 4 shows an example of a voltage divider formed according to one embodiment.

FIG. 5 shows a communication arrangement according to one embodiment.

FIG. 6 shows an electronic communication device according to one embodiment.

### DETAILED DESCRIPTION

The following detailed description relates to the attached figures which show details and exemplary embodiments. These exemplary embodiments are described in such detail that the person skilled in the art can implement the invention. Other embodiments are also possible and the exemplary embodiments can be modified in structural, logical and electrical terms without deviating from the subject-matter of the disclosure. The different exemplary embodiments are not necessarily mutually exclusive, but rather different embodiments can be combined with one another to produce new embodiments. In the context of this description, the terms “linked”, “connected” and “coupled” are used to describe both a direct and an indirect link, a direct or indirect connection, and a direct or indirect coupling.

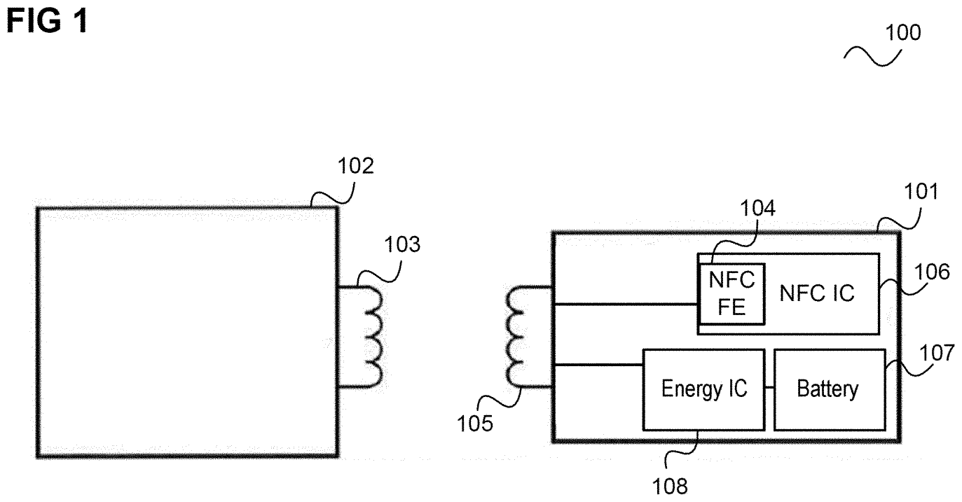

FIG. 1 shows a communication arrangement 100.

An NFC communication device 101 communicates with an NFC reader device 102, also referred to as a PCD (proximity coupling device)

If the NFC communication device 101 is passive, the NFC reader device 102 determines, via a reader antenna 103, a reader field which modulates a front-end 104 for contactless communication of the NFC communication device 101 using an NFC (coil) antenna 105, so that a communication circuit 106 can transmit data to the NFC reader device 102. The front-end 104 is regarded here as part of the communication circuit 106.

If the NFC communication device 101 is an active communication device, it has an active front-end 104 by means of which the communication circuit 106 transmits radio signals via the NFC antenna 105 to the reader device 102, wherein the reader device 102 receives said radio signals by means of the reader antenna 103. In this case, the front-end 104 modulates a carrier signal in order to transmit data to the reader device 102. A corresponding carrier wave having a certain carrier frequency is provided, for example, by a frequency generator. The communication circuit 106 further receives radio signals from the reader device 102 by means of the NFC antenna 105 and the front-end 104, wherein the reader device 102 emits said radio signals by means of the reader antenna 103.

In this example, it is assumed that the NFC communication device 101 is provided with a battery 107 in order to supply the NFC communication device 100 with energy. The NFC communication device 100 is therefore a device which has an energy supply (typically an accumulator) and supports NFC communication, for example for cashless payments. Examples of communication devices of this type are cell phones, watches (smartwatches) or other wearable devices which support NFC.

In order to charge the battery 107, the NFC communication device 101 can generate energy from the field emitted by the NFC reader device 102. According to WLC (wireless charging), the NFC reader device is referred to in such a case as a wireless charging poller (WLC-P) and the NFC communication device 101 is referred to as a wireless charging listener (WLC-L).

In order to be able to generate energy from the field emitted by the NFC reader device 102 and thus be able to charge the battery 107, the NFC communication device 102 has an energy generation circuit 108 which is connected along with the communication circuit 106 to the NFC antenna 105.

The communication circuit 106 and/or the energy generation circuit 108 is/are, for example, integrated circuits. They can be implemented by means of the same chip or with separate chips (possibly using different chip technologies).

The energy generation circuit 108 has, for example, a rectifier, a voltage limiter (e.g. a shunt) and/or a converter (e.g. a DC voltage converter). If the energy generation circuit 108 is configured to charge a battery 108, the energy generation circuit 108 can also have, for example, circuit parts which check the state of charge of the battery 107 and, where appropriate, stop the energy feed to the battery 107. The energy generation circuit 108 can also have, for example, circuit parts which are configured to communicate with the communication circuit 106, e.g. in order to indicate whether energy is or is not required to charge the battery 108, and the NFC communication circuit 106 can accordingly request energy from the NFC reader device 102 or indicate that the NFC reader device 102 needs to transmit no energy or a restricted amount of energy to the NFC communication device 102. The energy generation circuit 108 can have further components such as a rectifier or one or more buffer capacitors which, for example, supply an integrated charging circuit of the energy generation circuit.

If the communication circuit 106 is connected in parallel with the energy generation circuit 108 to the NFC antenna 105 (i.e. both the communication circuit and the energy generation circuit are connected with their connections to the end connections of the NFC antenna 105), the energy generation circuit 108 is restricted by the communication circuit 106 (in particular by a voltage regulator provided in or on the communication circuit 106).

According to different embodiments, an approach is therefore provided whereby the voltage is divided between the communication circuit 106 and the energy generation circuit 108. This enables the optimisation (or at least improvement) of the energy distribution in the WLC-L 101. The voltage divider can be designed independently from the geometry and the electrical characteristics of the NFC antenna 105 so that the energy generation is improved without impairing the communication capabilities of the WLC-L 101. The NFC antenna 105 can thus be used in one system in parallel with the energy generation for an NFC communication interface and communication services such as electronic payments.

According to different embodiments, it is provided that the communication circuit 106 uses the same (coil) antenna for NFC communication as that used by the energy generation circuit 108 for energy generation, but the communication circuit 106 does not use all turns, i.e. it uses a different (small) number of turns compared with the energy generation circuit 108. The number of turns which the communication circuit 106 uses can be chosen in such a way that the voltage distribution and/or energy distribution or energy intake is/are optimized.

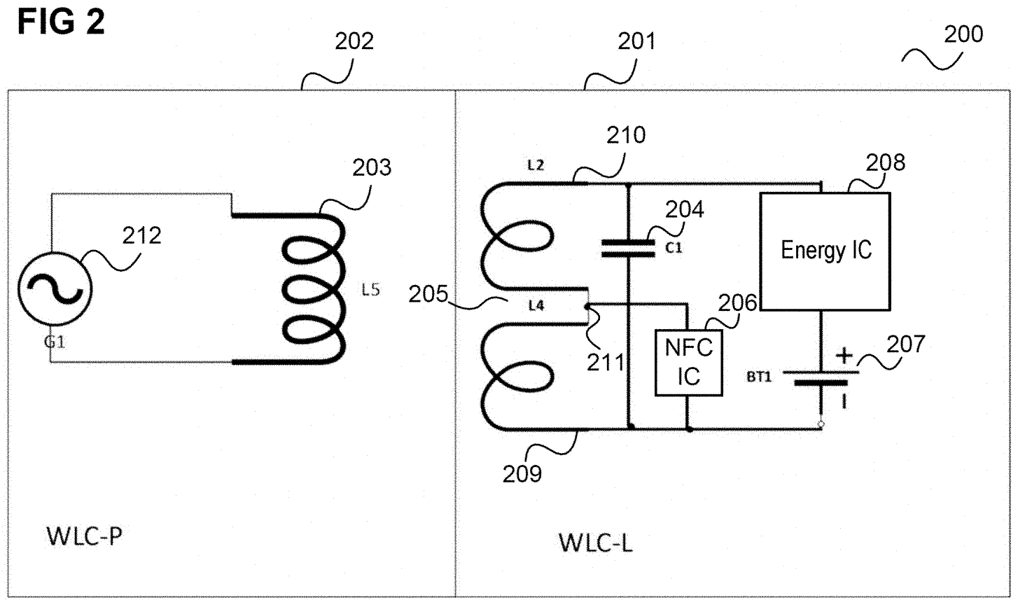

FIG. 2 shows a communication arrangement 200 with a communication device 201 according to one embodiment.

With the communication device 201, the communication arrangement 200 has a WLC-L 201 (e.g. corresponding to the NFC communication device 101). It also has a WLC-P 202 (e.g. corresponding to the NFC reader device 102) with a (reader) antenna 203.

The WLC-P 202 transmits electromagnetic oscillations by means of a reader antenna 203 by means of a defined (fundamental) frequency, e.g. a (possibly modulated) carrier signal which is provided by a signal source 212 and thus emits an electromagnetic (reader) field.

Similar to the NFC communication device 101, the WLC-L 201 has a communication circuit 206 (e.g. an NFC tag), an energy generation circuit 208, a battery 207 and an NFC antenna 205. The communication circuit 206 contains a front-end as described with reference to FIG. 1 (not shown separately here).

The energy generation circuit 208 is configured to generate energy from the field emitted by the WLC-P 202 and charge the battery 207 therewith. It can thus also be regarded as an energy generation and charging circuit.

With a capacitor 204 between its end connections 209, 210, the NFC antenna 205 forms a resonant circuit whose resonant frequency depends on the inductance of the NFC antenna 205 and the capacitor 204, and is set in a suitable manner. In order to set the resonant frequency of the system, the capacitor 204 can alternatively be connected between an end connection and mid-connection of the NFC antenna 205.

The energy generation circuit 208 is connected here (in this example in series with the battery 207) between the end connections 209, 210, of the NFC antenna 205. Conversely, the communication circuit 206 is connected between a mid-connection 211 (or mid-tap) and one of the end connections 209 of the NFC antenna 205.

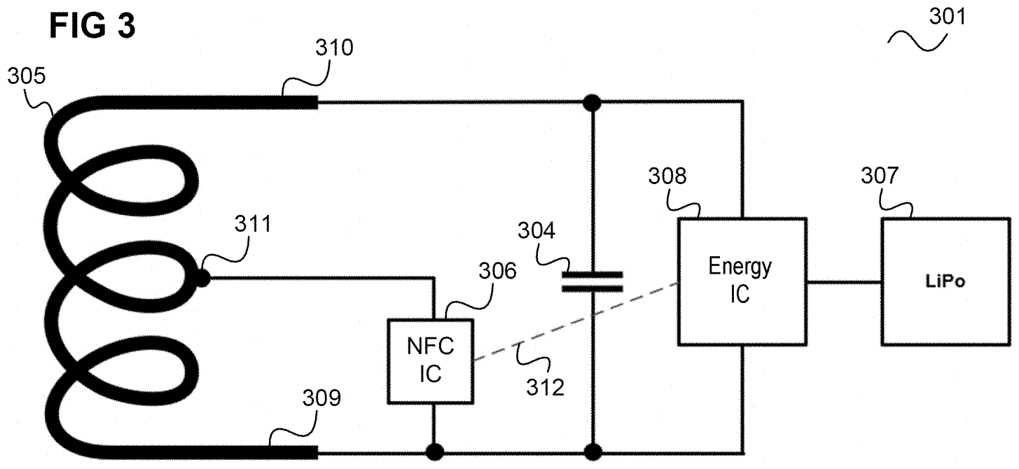

FIG. 3 shows a communication device 301 according to a further embodiment.

Similar to the communication device 201 from FIG. 2, the communication device 301 has a communication circuit 306, an energy generation circuit 308, a battery 307 and an NFC antenna 305 with a parallel capacitor 304. In this example, the energy generation circuit 308 is connected alone (i.e. not in series with the battery 307) between the end connections 309, 310, of the NFC antenna 305. The battery 307 is connected to the energy generation circuit 308 for charging. As in FIG. 2, the communication circuit 306 is connected between a mid-connection 311 of the NFC antenna 305 and one of the end connections 309.

The battery is, for example, a lithium-polymer (LiPo) battery and the energy generation circuit correspondingly implements a lithium-polymer battery charging circuit.

A communication interface 312 can be provided between the communication circuit 306 and the energy generation circuit 308. This enables, for example, the energy generation circuit 308 to communicate via the communication circuit 306 on the respective WLC-Ps with regard to energy transmission (e.g. to request energy or to indicate that energy is no longer required).

The communication circuit 306 clearly uses only some of the turns of the NFC antenna 205, 305, whereas the energy generation circuit 208, 308 uses all turns. A voltage divider is thus formed whose division ratio depends on the position of the mid-connection 211, 311.

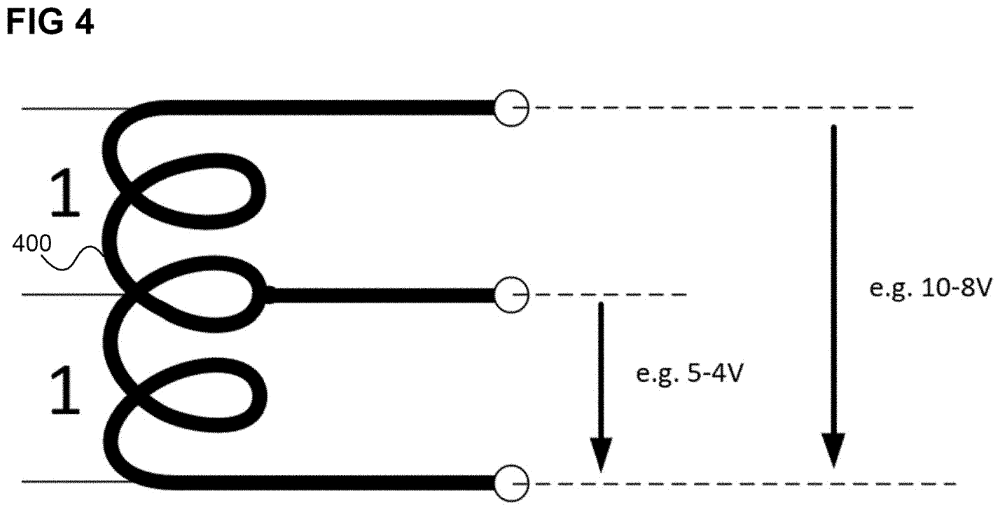

FIG. 4 shows an example of a voltage divider formed according to one embodiment.

In the simple example shown in FIG. 4, the division is one-to-one, i.e. the mid-connection 211, 311 is arranged according to half of the turns of the NFC (coil) antenna 400. If the full NFC antenna 400 then supplies a voltage of 8V-10V (depending on the load regulation and/or voltage limitation which can be performed by the energy generation circuit and/or the communication circuit), the part of the antenna 400 (here the half) supplies a voltage of 4V-5V. A low voltage of this type can be used by standard NFC chips. The higher voltage (8V-10V) can be used efficiently by charging circuits or energy generation circuits for e-Ink displays and much more.

The energy generation circuits 208, 308 and the communication circuits 206, 306 can be integrated circuits and can be arranged together on one board, e.g. together with the (e.g. LiPo) battery and the coil antenna, e.g. in a housing of a smartwatch.

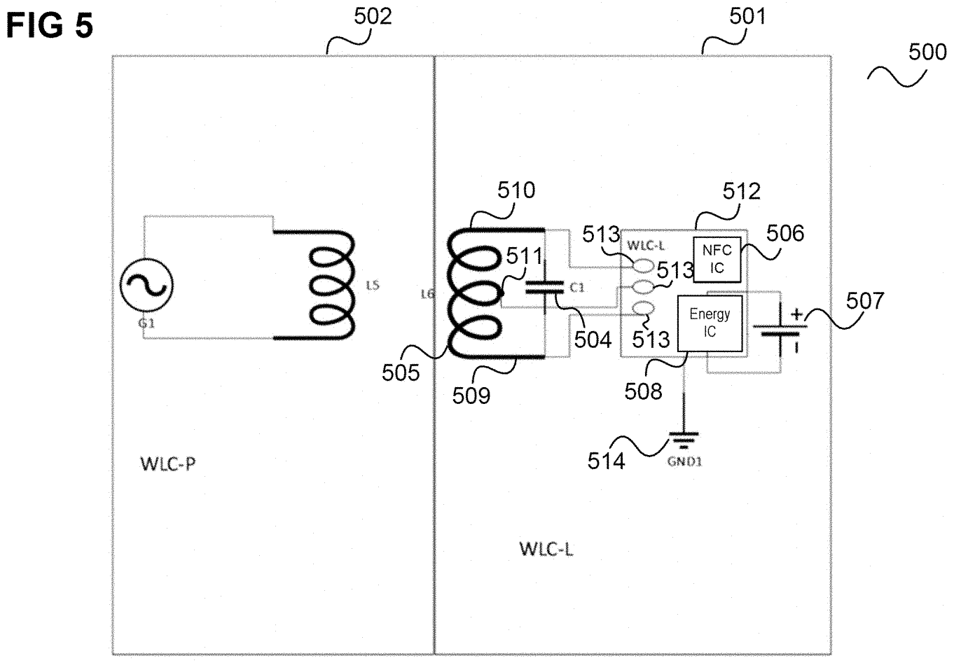

The energy generation circuits 208, 308 and the communication circuits 206, 306 can also be implemented by means of a single chip (e.g. an SoC (system on chip)), as shown in FIG. 5.

FIG. 5 shows a communication arrangement 500 according to one embodiment.

Similar to the communication arrangement 200 from FIG. 2, the communication arrangement 500 has a WLC-L 501 and a WLC-P 502.

The WLC-L 501 has an NFC antenna 505 with a parallel capacitor 504, a communication circuit 506, an energy generation circuit 508 and a battery 507. The communication circuit 506 and the energy generation circuit 508 are implemented together by means of a chip 512. The chip 512 has connections 513 with which it is connected to the mid-connection 511 or the end connections 509, 510 of the NFC antenna 505. The chip 513 further has a connection to a reference potential 514 and to the battery 507.

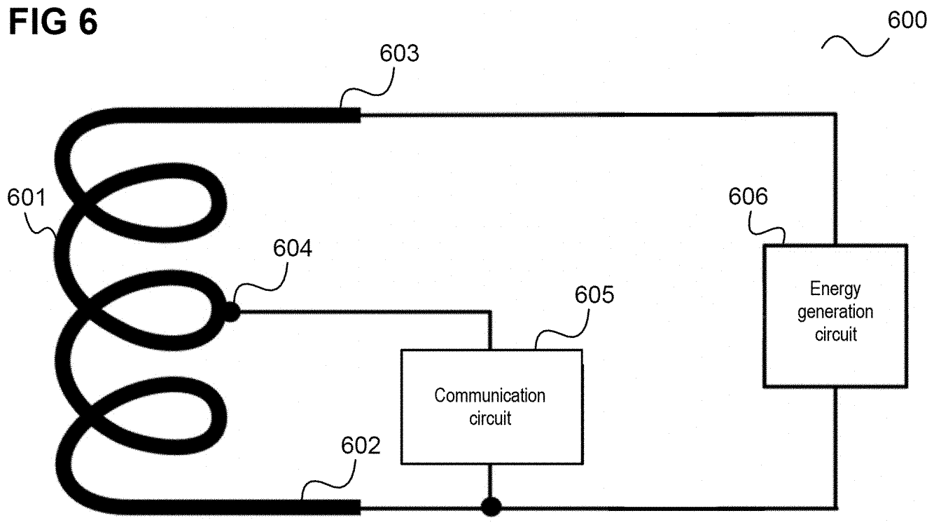

To summarize, a communication arrangement as shown in FIG. 6 is provided according to different embodiments.

FIG. 6 shows an electronic communication device 600 according to one embodiment.

The electronic communication device 600 has a coil antenna 601 having a first end connection 602, a second end connection 603 and a mid-connection 604.

The electronic communication device 600 further has a communication circuit 605 which is connected between the first end connection 602 and the mid-connection 604 and is configured to communicate by means of the coil antenna 601 with another communication device, and an energy generation circuit 606 which is connected between the first end connection 602 and the second end connection 603 and is configured to receive energy via the coil antenna 601 and to supply at least one component of the electronic communication device 600 with the received energy.

In other words, in an NFC communication device, a communication circuit is coupled to a smaller part of a coil antenna (i.e. is connected in parallel to a smaller part of the coil antenna) than an energy generation circuit (which is connected, for example, in parallel with the entire coil antenna). The communication circuit is therefore coupled (i.e. connected) with its antenna connections to a mid-connection of the coil antenna and the energy generation circuit is coupled (i.e. connected) with its antenna connections to the end connections of the coil antenna. Here, “connected to a connection of the antenna” is to be understood to mean that the connection is the first connection point of the respected component to the antenna (i.e. the connection is not a connection which is formed by the antenna or a section of the antenna itself and therefore runs via a different connection point).

The mid-connection therefore divides the coil antenna into two sections (not necessarily in a one-to-one ratio) and the communication circuit is connected in parallel with one of the sections and the energy generation circuit is connected (possibly with a further component, such as the battery 107 in FIG. 1) in parallel with the two sections (i.e. the entire coil antenna).

The capacitance for setting the resonant frequency of the system can be replicated in the electronic communication device 600 by means of the parasitic capacitance of the NFC antenna 601 (and antenna designs connected thereto) and/or by means of integrated capacitances of the communication circuit 605 and or the energy generation circuit 606.

The procedure shown in FIG. 6 results in an increased service life of the communication device, since no load is imposed on the front-end of the communication circuit due to the limited voltage which is applied to the communication circuit, since the latter is connected between the mid-connection and an end connection (and therefore a smaller potential difference than between the two end connections). The mid-connection is chosen, for example, in such a way that the voltage which is applied to the communication circuit is sufficient for communication (e.g. NFC communication), but does not exceed this to the extent that it imposes a load on its front-end. The energy generation circuit can, for example, charge an LiPo battery and, although the voltage required to operate an energy generation circuit of this type is around 4-6 V, the communication circuit can operate at lower voltages (e.g. 3V) with the architecture shown in FIG. 6.

The energy generation circuit (e.g. a voltage regulator, e.g. LDO (low dropout)) can perform a voltage limitation, e.g. to a relatively high voltage for energy generation (e.g. for charging or for other energy supply functions). With a corresponding reader field, a suitably designed coil antenna (e.g. with a corresponding number of turns) can provide a sufficient voltage (i.e. a corresponding voltage is induced) between its end connections. No step-up converter (e.g. direct-current converter) is therefore required for the energy generation circuit. This “high” voltage regulation can be controlled via current mirrors, etc, through the use of a communication circuit (e.g. an NFC chip) with similar output voltage capabilities. The energy generation circuit and the communication circuit can therefore be free from direct-current converters.

Different exemplary embodiments are indicated below.

Exemplary embodiment 1 is an electronic communication device as described with reference to FIG. 6.

Exemplary embodiment 2 is an electronic communication device according to exemplary embodiment 1, wherein the communication circuit is a near-field communication circuit.

Exemplary embodiment 3 is an electronic communication device according to exemplary embodiment 1, wherein the communication circuit is a near-field communication circuit.

Exemplary embodiment 4 is an electronic communication device according to one of exemplary embodiments 1 to 3, having a battery, wherein the energy generation circuit is configured to charge the battery by means of energy received via the coil antenna.

Exemplary embodiment 5 is an electronic communication device according to exemplary embodiment 4, wherein the battery is a lithium-polymer battery.

Exemplary embodiment 6 is an electronic communication device according to one of exemplary embodiments 1 to 5, wherein the energy generation circuit is connected in series with the at least one component between the first end connection and the second end connection.

Exemplary embodiment 7 is an electronic communication device according to one of exemplary embodiments 1 to 6, wherein the energy generation circuit has a limitation circuit which is configured to limit the voltage between the first end connection and the second end connection.

Exemplary embodiment 8 is an electronic communication device according to exemplary embodiment 7, wherein the mid-connection is arranged in such a way and wherein the limitation circuit is configured in such a way as to limit the voltage between the first end connection and the second end connection in such a way that the voltage between the first end connection and the mid-connection is limited to a maximum voltage supported by the communication circuit.

Exemplary embodiment 9 is an electronic communication device according to one of exemplary embodiments 1 to 8, having a chip which implements the communication circuit and the energy generation circuit.

Exemplary embodiment 10 is an electronic communication device according to one of exemplary embodiments 1 to 9, wherein the coil antenna has at least one turn between the first end connection and the mid-connection and at least one turn between the mid-connection and the second end connection.

Although the invention has been shown and described above all with reference to specific embodiments, it should be understood by those persons who are familiar with the technical field that numerous modifications can be made in respect of the design and details without deviating from the essence and scope of the invention as defined by the following claims. The scope of the invention is therefore defined by the attached claims, and it is intended that all modifications which fall within the meaning or equivalence range of the claims are encompassed.

### REFERENCE NUMBER LIST

100 Communication arrangement
101 NFC communication device
102 NFC reader device
103 Reader antenna
104 Front-end
105 NFC antenna
106 Communication circuit
107 Battery
108 Energy generation circuit
200 Communication arrangement
201 WLC-L
202 WLC-P
203 Reader antenna
204 Capacitor
205 NFC antenna
206 Communication circuit
207 Battery
208 Energy generation circuit
209, 210 End connections
211 Mid-connection
212 Signal source
301 Communication device
304 Capacitor
305 NFC antenna
306 Communication circuit
307 Battery
308 Energy generation circuit
309, 310 End connections
311 Mid-connection
312 Communication interface
400 Coil antenna
500 Communication arrangement
501 WLC-L
502 WLC-P
504 Capacitor
505 NFC antenna
506 Communication circuit
507 Battery
508 Energy generation circuit
509, 510 End connections
511 Mid-connection
512 Chip
513 Chip connections
600 Electronic communication device
601 Coil antenna
602, 603 Coil end connections
604 Coil mid-connection
605 Communication circuit
606 Energy generation circuit

1. An electronic communication device having, comprising:
a coil antenna with a first end connection, a second end connection, and a mid-connection;
a communication circuit, which is connected between the first end connection and the mid-connection, and is configured to communicate with another communication device via the coil antenna; and
an energy generation circuit, which is connected between the first end connection and the second end connection, and is configured to receive energy via the coil antenna and to supply at least one component of the electronic communication device with the received energy.

2. The electronic communication device of claim 1, wherein the communication circuit is a near-field communication circuit.

3. The electronic communication device as claimed in claim 1, wherein the communication circuit is a near-field communication circuit to enable cashless payments.

4. The electronic communication device of claim 1, further comprising:
a battery, wherein the energy generation circuit is configured to charge the battery using energy received via the coil antenna.

5. The electronic communication device of claim 4, wherein the battery is a lithium-polymer battery.

6. The electronic communication device of claim 1, wherein the energy generation circuit is connected in series with the at least one component between the first end connection and the second end connection.

7. The electronic communication device of claim 1, wherein the energy generation circuit comprises a limitation circuit which is configured to limit voltage between the first end connection and the second end connection.

8. The electronic communication device of claim 7, wherein the mid-connection and the limitation circuit are arranged to limit voltage between the first end connection and the second end connection in such a way that voltage between the first end connection and the mid-connection is limited to a maximum voltage supported by the communication circuit.

9. The electronic communication device of claim 1, further comprising:
a chip which implements the communication circuit and the energy generation circuit.

10. The electronic communication device of claim 1, wherein the coil antenna comprises at least one turn between the first end connection and the mid-connection and at least one turn between the mid-connection and the second end connection.
